(19) United States
(12) Patent Application Publication
(10) Pub. No.: US 2022/0377853 A1
(43) Pub. Date: Nov. 24, 2022

(54) Thin Film Heater

(71) Applicant: JT International SA, Geneva (CH)

(72) Inventor: Tony Reevell, London (GB)

(73) Assignee: JT International SA, Geneva (CH)

(21) Appl. No.: 17/635,159

(22) PCT Filed: Aug. 28, 2020
(86) PCT No.: PCT/EP2020/074150

§ 371 Date: Feb. 14, 2022

(30) Foreign Application Priority Data
Sep. 6, 2019 (EP) 19196024.4

(51) Int. Cl. H05B 3/36

(52) U.S. Cl. CPC H05B 3/36; H05B 2203/013; H05B 2203/017; H05B 2203/003

(57) ABSTRACT

A method of fabricating a thin film heater includes a first step of etching a metal sheet from two opposing sides to provide a planar heating element; and a second step of attaching the heating element to a flexible electrically insulating backing film. The method allows for the fabrication of a thin film heater which provides more uniform heating and allows for greater range of selection of the properties of the flexible electrically insulating backing film and the parameters of the etching process. A heater assembly and an aerosol generating device incorporating the thin film are also described.

### TECHNICAL FIELD

The present invention relates to a thin film heater and a method for fabricating a thin film heater

### BACKGROUND

Thin film heaters are used for a wide range of applications which generally require a flexible, low profile heater which can conform to a surface or object to be heated. One such application is within the field of aerosol generating devices such as reduced risk nicotine delivery products, including e-cigarettes and tobacco vapour products. Such devices heat an aerosol generating substance within a heating chamber to produce a vapour and as such may employ a thin film heater which conforms to a surface of the heating chamber to ensure efficient heating of an aerosol-generating substance within the chamber.

Thin film heaters generally comprise a resistance heating element enclosed in a sealed envelope of flexible electrically insulating thin film, with contact points to the heating element for connection to a power source, the contact points usually soldered on to exposed parts of the heating element.

Such thin film heaters are generally manufactured by depositing a layer of metal onto the electrically insulating thin film support, etching the metal layer supported on the thin film into the required shape of the heating element, applying a second layer of electrically insulating thin film onto the etched heating element and heat pressing to seal the heating element with the electrically insulating thin film envelope. The electrically insulating thin film is then die cut to create openings for contacts which are soldered on to the portions of the heating element exposed by the openings.

The etching of the metal layer is generally achieved by screen printing a resist onto the surface of the metal foil, applying a resistance pattern, which may be designed in CAD, and transferring to the foil by selectively exposing the resist and then spraying the exposed surface of the metal layer with appropriate etch chemicals to preferentially etch the metal layer to leave the desired heating element pattern supported on the film.

Such conventional thin film heaters are relatively low cost and are widely available but suffer from a number of disadvantages. In particular, the precision in thickness of the etched heater pattern is limited, resulting in a corresponding limitation to the precision in the resistance across the heater track. This can cause unwanted variations in the local temperature of the heat element during use. The selection of the parameters of the etching processes is also constrained by the limited choice for the electrically insulating backing film and, in some cases by the fact that the etch chemicals can damage the film. Furthermore, this known process does not allow for significant variation in the heater structure as the etched pattern is limited by the size of the supporting film and the limitations of the chemical etching process.

The present invention aims to make progress in addressing these issues to provide an improved thin film heater and method for manufacturing a thin film heater.

### SUMMARY OF THE INVENTION

According to a first aspect of the invention, there is provided a method of fabricating a thin film heater comprising: etching a metal sheet from two opposing sides to provide a planar heating element; and attaching the heating element to a flexible electrically insulating backing film.

Alternatively stated, the method involves etching of a metal sheet to form a heating element before subsequently attaching the heating element to a flexible electrically insulating backing film, such that the etching of the metal sheet is carried out independently of the attachment of the heating element to the backing film.

As the etching of the metal sheet takes place before attachment onto a backing film, i.e. both planar surfaces of the metal sheet are exposed, the etch process can be carried out on both opposing planar surfaces of the metal sheet to achieve an increased precision in the dimensions of the etched heating element in comparison to methods in which the metal sheet is etched when supported on a surface. This increased precision in the width and/or thickness of the heater track of the heating element results in an increased precision in resistance and accordingly a greater uniformity of heating temperature across a heating area of the heating element. Etching of both sides of the metal sheet is particularly advantageous because of the subsequent attachment to a flexible backing film. Although single sided etching can be appropriate for general purpose surface heating elements which are attached to rigid surfaces, flexible backing films can be delicate and so defects in the etching of the heating element are more liable to damage the film and reduce the structural stability of the heater. By etching form both sides of the metal foil and subsequently attaching to the flexible film, a more robust thin film heater is provided.

Furthermore, since the etching process and the subsequent attachment onto a backing film are separate independent steps, the choice of the parameters of the etch process is not influenced by the particular backing film used. Similarly, the choice of backing film properties, such as material and thickness, is not influenced by the etch process used such that these selections may be optimised with the requirements of the final application in mind.

The etching of the heating element before application to a backing film also allows for greater design freedom in the shape of the heating element. When a metal sheet is first deposited on a backing film, the size of the metal sheet is limited by the backing film and so the size of the heating element is limited to this area. By etching a metal sheet independently of the backing film, the size and complexity of the heater element pattern is not restricted.

The etching step preferably comprises photoetching the metal sheet, for example by applying a photo-sensitive resist to both sides of the metal sheet; selectively exposing parts of both sides of the metal sheet to light to transfer a pattern corresponding to the heating element to the photo-sensitive resist; and applying etching chemicals to both sides of the sheets to selectively etch the metal sheet according to the transferred pattern. Selectively exposing parts of both sides of the metals sheet to light may involve using laser direct imaging to expose the metal sheet to ultraviolet light. This process allows for an intricate heating element pattern to be transferred, for example from a CAD file, onto the metal sheet with high precision and reproducibility, resulting in very little variation between heating elements.

Preferably, the heating element is attached to a surface of the flexible electrically insulating backing film using an adhesive, for example a silicon adhesive. This provides a straightforward means of reliably securing the heating element to the backing film. The flexible electrically insulating backing film may comprise a layer of adhesive, for example it may be polyimide film with a layer of Si adhesive. The heating element may be attached by subsequent heating of the flexible electrically insulating backing film, adhesive layer and positioned heating element to bond the heating element to the surface using the adhesive.

The etching step may comprise etching the metal sheet to provide two or more connected heating elements. The etching step may further comprise etching the metal sheet so as to provide two or more connected heating elements supported by a support structure, for example with the heating elements suspended within a support frame. The two or more connected heating elements may be in the form of an array comprising a plurality of connected heating elements. This allows for multiple heating elements to be prepared simultaneously increasing the efficiency of the method. The connected heating elements may be easily handled as an integral structure.

When etching the metal sheet to provide two or more connected heating elements, the method may further comprise detaching each heating element, i.e. removing a heating element from the array of two or more connected heating elements, and attaching each heating element to a corresponding piece of flexible electrically insulating backing film. In this way, the connected heating element are easily handled as an integral structure with an individual heating element released in a straightforward manner during the manufacturing process and attached to a piece of flexible electrically insulating backing film. The connected heating elements may be connected by connecting portions of reduced section, e.g. breakable portions, which connect the heating elements to each other and/or a supporting frame such that may be released by breaking or cutting the connecting portions.

Alternatively, when etching the metal sheet to provide two or more connected heating elements, the method may further comprise attaching the connected heating elements to a common flexible electrically insulating backing film and cutting the flexible electrically insulating backing film between the heating elements to provide multiple assemblies comprising a single heater element attached to a flexible backing film. In this way, multiple thin film heaters may be assembled simultaneously thereby enhancing the manufacturing efficiency. When the connected heater elements are supported within a support frame, the support frame may comprise a plurality of alignment holes arranged to allow alignment of the connected heating elements relative to a flexible electrically insulating backing film. The method may comprise positioning a row of two or more connected heating elements onto an adhesive surface of a strip of flexible electrically insulating backing film, attaching a second piece of flexible film so as to at least partially enclose two or more connected heating elements between the flexible electrically insulating backing film and second flexible film; and cutting between the connected heating elements to release two or more sealed thin film heating elements.

Preferably the method comprises etching the metal sheet to form a planar heating element comprising: a heater track which follows a circuitous path covering a heating area within the plane of the heating element; and two extended contact legs for connection to a power source. The contact legs may be sufficiently long to allow direct connection to a power source when the thin film heater is employed in the device. For example the length of the contact legs may be substantially equal or greater than one or both of the dimensions defining the heating area. The circuitous path may be configured to leave a vacant region within the heating area. The heating area may be the area defined by the maximum length and maximum width of the heating element. The method may further comprise positioning a temperature sensor in the vacant region.

Preferably the method further comprises attaching a second flexible film layer so as to enclose the heater track between the backing film and the second flexible film layer. Preferably the heater track is enclosed between the backing film and the second flexible film layer while leaving the contact legs exposed to allow connection to a power source. The second flexible film layer may comprise a heat shrink material. By using a heat shrink material, the second flexible film can be used to attach the thin film heater to the surface of a heating chamber. More particularly the layer of attached heat shrink film comprises an attachment region which extends beyond the flexible backing film in a wrapping direction wherein the attachment region can be wrapped around the external surface of a heating chamber to hold the thin film heater against the surface; the assembly may then be heated to shrink the heat shrink film securing the thin film heater to the surface of the heating chamber.

The flexible electrically insulating backing film may comprise polyimide, a fluoropolymer such as Polytetrafluoroethylene (PTFE) or Polyetheretherketone (PEEK). The thickness of the flexible electrically insulating backing film is preferably less than 50 μm, more preferably less than 30 μm. For example the backing film may comprise single sided 25 μm PI with 37 μm Si adhesive. The heat shrink material may also comprise polyimide, a fluoropolymer such as

Polytetrafluoroethylene (PTFE) or Polyetheretherketone (PEEK). The backing film is preferably liquid impermeable. Providing a thickness of the flexible electrically insulating backing film of less than 50 μm provides optimal heat transfer properties for the application of the thin film heater in an aerosol generating device. In particular this allow for good heat transfer through the backing film, while ensuring sufficient structural stability to support the heating element. The structural stability may be further enhanced by providing a backing film with a minimum thickness of 5 μm.

According to a further aspect of the invention, there is provided a thin film heater fabricated according to a method as defined above or in the appended claims. In particular the thin film heater according to the present invention comprises a planar heating element attached to the surface of a flexible electrically insulating backing film. The planar heating element is etched from a metal sheet from two opposing sides to provide a planar heating element. Preferably the planar heating element comprises: a heater track which follows a circuitous path covering a heating area within the plane of the heating element; and two extended contact legs for connection to a power source. Preferably the length of the contact legs is substantially equal or greater than the dimensions of the heating area. Preferably the thin film heater further comprises a second flexible film layer so as to enclose the heater track between the backing film and the second flexible film layer, preferably leaving the contact legs exposed. Preferably the second flexible film layer comprises a heat shrink material.

According to a further aspect of the invention there is provided a planar heating element assembly comprising two or more connected heating elements wherein the planar heating assembly is etched from a metal sheet from two opposing sides. Preferably the heating element assembly further comprises a support frame and the two or more connected heating elements are supported within the support frame. Preferably each heating element comprises a heater track which follows a circuitous path covering a heating area within the plane of the heating element; and two extended contact legs for connection to a power source.

According to a further aspect of the invention there is provided a heater assembly comprising a thin film heater fabricated according to a method as defined in the appended claims and a heating chamber; wherein the thin film heater is wrapped around an external surface of the heating chamber.

According to a further aspect of the invention there is provided an aerosol generating device comprising a thin film heater fabricated according to a method as defined in the appended claims.

### BRIEF DESCRIPTION OF THE DRAWINGS

Embodiments of the invention will now be described, by way of example only, with reference to the accompanying drawings, in which:

FIGS. 1A to 1F illustrates a method of etching a metal sheet from two opposing sides to provide a planar heating element;

FIG. 2A illustrates a planar heating element according to the present invention;

FIG. 2B illustrates a plurality of connected heating elements fabricated according to the method of the present invention;

FIGS. 3A and 3B illustrate a thin film heater fabricated according to the method of the present invention;

FIG. 4A to 4F illustrates a method of assembling a heater assembly using a thin film heater fabricated according to the method of the present invention;

FIG. 5 illustrates a method of fabricating multiple thin film heaters according to the method of the present invention;

FIG. 6 illustrates an aerosol generating device comprising a thin film heater fabricated according to the method of the present invention;

### DETAILED DESCRIPTION

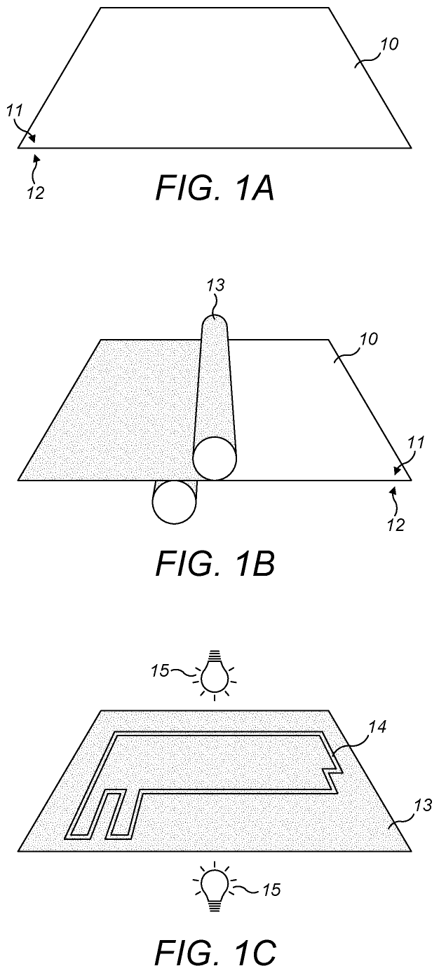

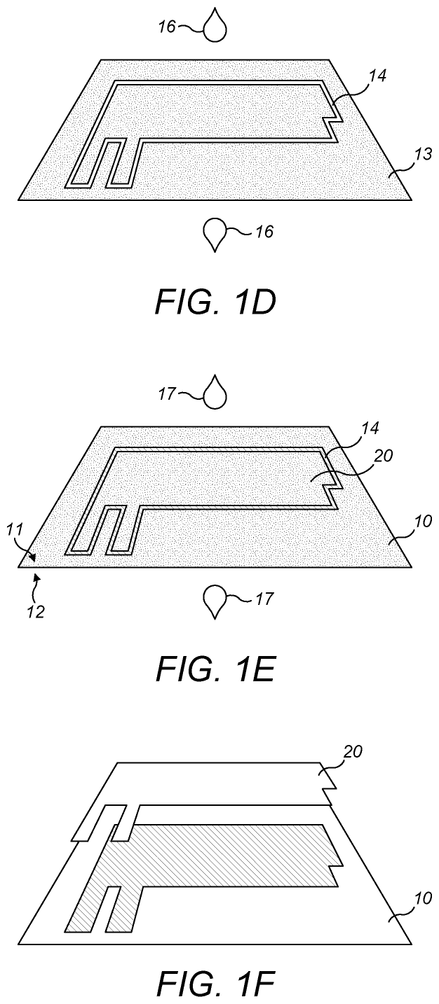

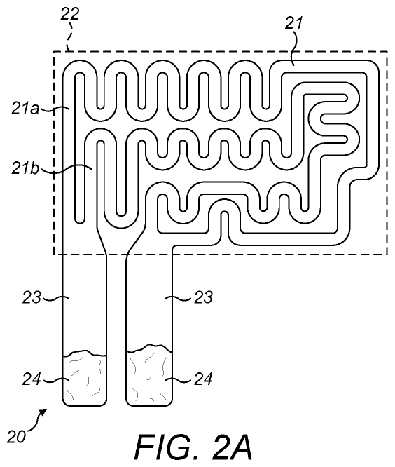

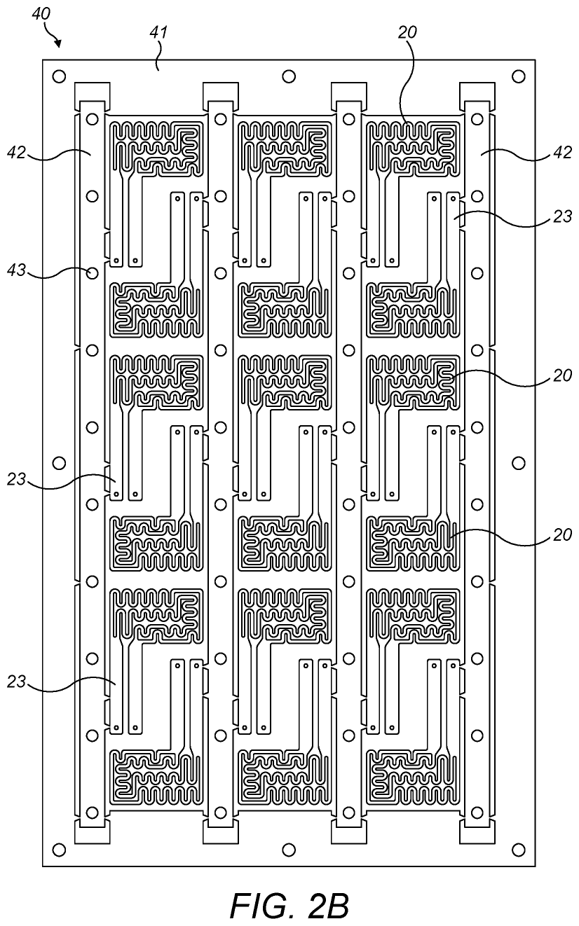

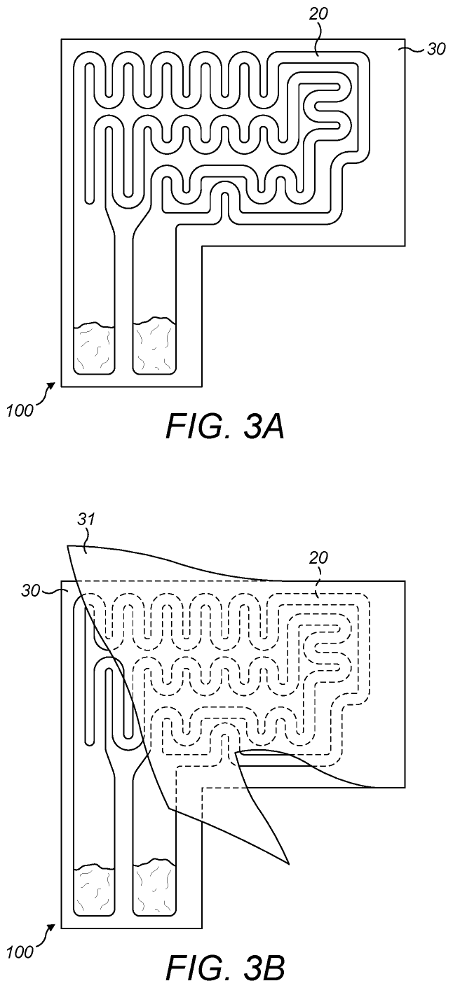

The present invention provides a method of fabricating a thin film heater comprising the steps of etching the metal shield from the two opposing sides, as shown in FIG. 1, in order to provide a planar heating element as shown in FIG. 2A; and attaching the heating element to a flexible electrically insulating backing film as shown in FIG. 3A.

FIG. 1 schematically illustrates an exemplary method of etching a metal sheet 10 from two opposing sides 11, 12 to provide a planar heating element 20.

Various possible techniques may be used to etch the metal sheet 10, the important common aspect being that the etching of the metal sheet takes place independently of the flexible backing film 30, allowing the metal sheet 10 to be etched from both sides 11, 12 resulting in improved precision, greater design freedom in the specific shape of the heating element 20 and greater selection in the specific parameters of the etching process.

The method begins with selecting an appropriate material for the thin metal sheet (or metal “foil”) 10. Sheets of stainless steel, for example 18 SR or SUS 304, with a thickness of around 50 micrometres provide appropriate properties when fabricated into a heating element, whilst being relatively easy to handle and etch as required. The specific metal and thickness of the metal sheet 10 are selected such that the resulting heating element 20 is flexible such that it can deform with the supporting flexible thin film 30 in order to conform to the shape of a surface to be heated.

The metal foil 10 may first be cleaned and degreased to remove any dirt or remnants of the fabrication process such as waxes and rolling oils to improve the application of the photoresist and efficacy of the etch chemicals. The next step, shown in FIG. 1B, is to apply a photo sensitive resist 13 to both sides 11, 12 of the metal sheet 10. The photo resist 13 may be applied using an automated lamination process under clean conditions to ensure the photo resist layer adheres to the surfaces 11, 12 of the metal sheet 10.

Next, as shown in FIG. 1C, a pattern 14 corresponding to the heating element 20 is transferred to the photo resist layers 13 on both sides of the metal sheet 10 by selectively exposing parts of both sides 11, 12 to ultraviolet light 15. The pattern is preferably transferred using a computer controlled laser 15 to transfer the heater element design pattern 14 (for example as held in a CAD file) to the photo resist 13 using the laser 15. Laser direct imaging (LDI) can be used to accurately transfer the intricate heating element pattern to the photo resist using the ultraviolet light of the laser.

Next, as shown in FIG. 1D, the unexposed photo resist is removed to expose the surface of the metal sheet. The portions of the photo resist 13 which have been exposed to UV light to harden the photo resist to protect the remainder of the metal sheet during etching. Appropriate chemicals 16 are applied during this developing step which remove the unexposed resist but have no effect on the hardened photo resist exposed to the UV light.

After the developing step, appropriately selected etch chemicals 17 are applied to both sides 11, 12 of the metal sheet 10 to etch the exposed portion 14 of the metal sheet 10 to free the etched heating element 20 from the metal sheet 10.

The etch chemicals 17 are selected according to the specific material and thickness used for the metal sheet 10. Finally, as shown in FIG. 1F, further chemicals are applied to remove the remaining photo resist 13 from the metal sheet 10 to reveal the etched heating element 20 which is freed from the metal sheet 10.

By etching a metal sheet 10 from both sides, in contrast to prior art methods in which a deposited layer of metal is etched on a substrate, a freestanding etched metal heater element 20 is provided as shown in FIG. 2A or multiple connected metal heater elements 20 are provided as shown in FIG. 2B. As shown in FIG. 2A, the heater element 20 comprises a heater track 21 which follows a circuitous path to substantially cover a heating area 22 within the plane of the heating element 20, and two extended contact legs 23 for connecting the heating element 20 to a power source. The heating element 20 is configured such that, when the contact legs 23 are connected to a power source and the current is passed through the heating element 20, the resistance in the heater track 21 causes the heating element 20 to heat up. The heater track 21 is preferably shaped so as to provide substantially uniform heating over the heating area 22. In particular, the heater track 21 is shaped so that it contains no sharp corners and has a uniform thickness and width with the gaps between neighbouring parts of the heating track being substantially constant to minimise increased heating in specific areas over the heater area 22. The heater track 21 follows a winding path over the heater area 22 whilst complying with the above criteria. The heater track 21 in the example of FIG. 2A is split into two parallel heater track paths 21a and 21b which each follow a serpentine path over the heater area 22. The heater legs 23 may be soldered at connection points 24 to allow the connection of wires to attach the heater to the PCB and power source.

There are several advantages relating to the heating element 20 prepared by the method of the present invention in comparison with heating elements prepared by conventional methods in which a metal sheet is first applied to an electrically insulating substrate and subsequently etched from the exposed side to provide a heater pattern disposed on the substrate. In particular, by etching from both planar sides 11, 12 of the metal sheet 10 an increased precision in terms of the width of the heater tracks 21 may be achieved. This results in a corresponding increased precision in the resistance along the heater tracks 21 (which is related to the thickness) and as such a more uniform temperature is provided across the heating area 22. Furthermore, since the metal sheet 10 is etched independently of the electrically insulating substrate, the properties of the electrically insulating substrate do not need to be taken into account when choosing the various chemicals used in the etching process. In the conventional method, when the metal sheet is first deposited on a substrate prior to etching, the properties of the electrically insulating substrate can limit the choice in the specific etching steps used. Similarly, the selection of the material for the electrically insulating backing film may be restricted as it must be robust to the etching process. Therefore, in prior art methods, an electrically insulating layer must be selected which can withstand the chemicals of the etching process and it must be an appropriate thickness such that it does not significantly degrade during the etching process. Clearly, by providing an increased thickness of an electrically insulating layer, the heat transfer efficiency is limited due to the greater amount of material surrounding the heating element 20. By etching the metal sheet 10 in a separate step, prior to attachment to the electrically insulating backing film a thinner electrically insulating backing film may be used such that the final heating element provides greater heat transfer efficiency.

As described above, one of the advantages of the present technique is that it allows for greater design freedom in selecting the specific shape of the heater element. FIG. 2B illustrates an array of connected heating elements 20 which can be fabricated by etching a single metal sheet 10. The specific array of heating elements depicted in FIG. 2B comprises three strips of six heating elements 20, each supported within a surrounding support frame 41, wherein this entire composite structure is etched from a single metal sheet 10 using the method illustrated in FIG. 1. Clearly, the method is not limited in the number or arrangement of heating elements 20 or the specific form of the supporting frame structure 41.

By etching the metal sheet to form a plurality of connected heating elements 20, the process of assembling the heating elements into the final thin film heater 100 may be greatly simplified and rendered more efficient. Furthermore, the properties of the heating elements 20 prepared together in this way may be more consistent. If being assembled by hand, the heating elements may simply be released from the support frame by breaking or cutting fragile breakable connecting portions of heater sheet material which connect the heating elements 20 to the neighbouring support struts 42 of the frame 41. The released heating elements 20 can then simply be attached to corresponding flexible electrically insulating backing films.

Alternatively, as will we described below, the array 40 of heating elements 20 may be attached together to single common piece of backing film 30 before the individual heating elements 20 and the corresponding regions of backing film to which they are attached are cut from a backing film sheet. This allows for multiple thin film heaters 100 to be produced simultaneously in a simplified and efficient process. To aid with such a process the support struts 42 may include a number of alignment holes 43 which can be used for aligning the array of heating elements 40 in the manufacturing equipment for correct orientation relative to the electrically insulating layer to which they are affixed.

FIG. 2B further illustrates how the specific shape of the heating element 20 may be optimised when fabricating the heating element 20 using the method according to the present invention. For example, the heater legs 23 may be extended in length such that in the final assembled device the contact heater legs 23 may be connected directly to the PCB, removing the need for soldering contacts 24, as shown in FIG. 2A, and subsequently connecting the heater legs 23 with cables to the PCB. This is because the dimensions of the heating element pattern are not restricted by the dimensions of the supporting film to which the metal sheet is applied, as in the prior art method.

As shown in FIG. 3A, the etched heating element 20 is next attached to a flexible electrically insulating backing film 30 to form a thin film heater 100. Suitable materials for the flexible backing film 30 include polyimide, fluoropolymers such as Polytetrafluoroethylene (PTFE) or Polyetheretherketone (PEEK) to which the heating element 20 may be attached on one surface of the thin film. The heating element 20 is attached by use of an adhesive, for example a Silicon adhesive, to stick the planar heating element to the flexible backing film 30. The method allows for thinner backing films to be used since they are not exposed to the etch process. For example, a film of 25-micrometre polyimide with 37-micrometre silicone adhesive may be used wherein the heating element 20 is stuck to the adhesive layer on the polyimide film. Similarly, the method according to the present invention allows for alternative backing film materials to be used, which otherwise would be degraded during the etch process. For example, the flexible electrically insulating backing layer 30 may be PTFE or other possible heat resistant, electrically insulating polymer materials, such as those identified above.

The process of attaching the heating element 20 to the backing film 30 with the adhesive may be achieved in a number of different ways. Firstly a single heating element 20 may simply be placed on the adhesive side of the polyimide film as shown in FIG. 3A. Alternatively, if the heating elements 20 are prepared in an arrangement 40 comprising a plurality of connected heating elements 20 as shown in FIG. 2B the heating element may be released individually from the supporting frame 41 before attaching to the polyimide backing film 30. The resulting thin film heater 100 shown in FIG. 3A may then be applied to the external surface of a heating chamber by wrapping the thin film heater around the heating chamber. Prior to attachment to a heating chamber the thin film heater 100 may be stored by applying a release layer 31 to the surface of the backing film 30, as shown in FIG. 3B, which supports the heating element 20. Since the adhesive layer is exposed in the areas around the heating element 20 the release layer may simply be stuck to this silicone adhesive layer and the heater stored in this state.

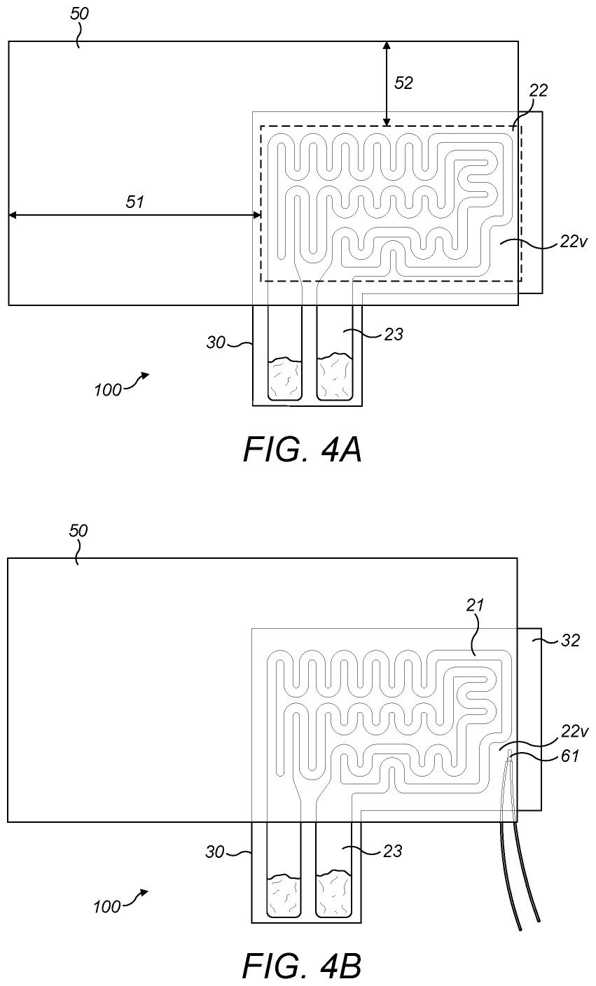

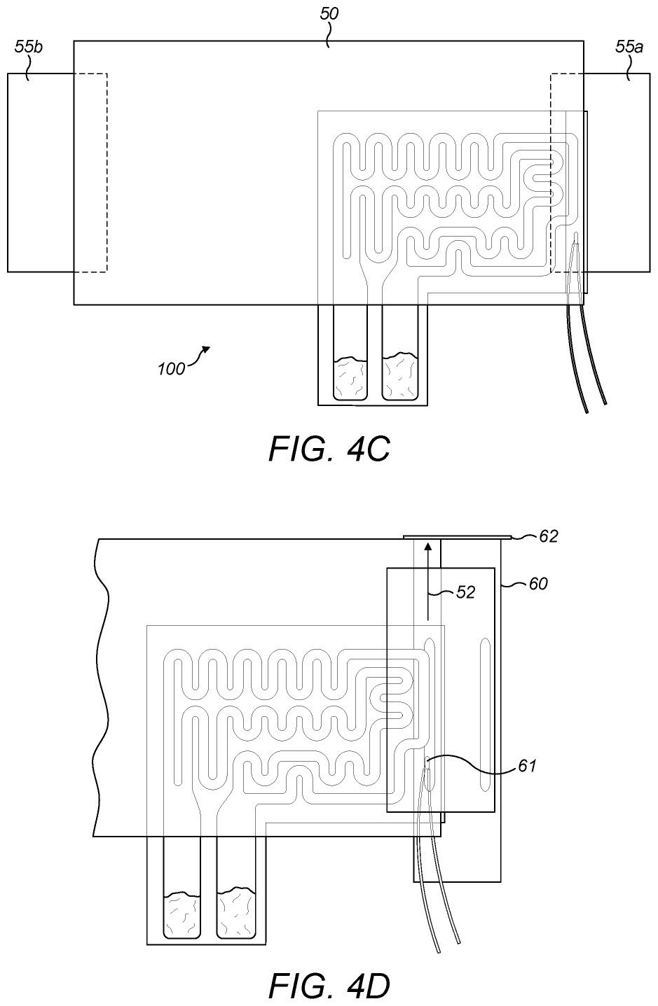

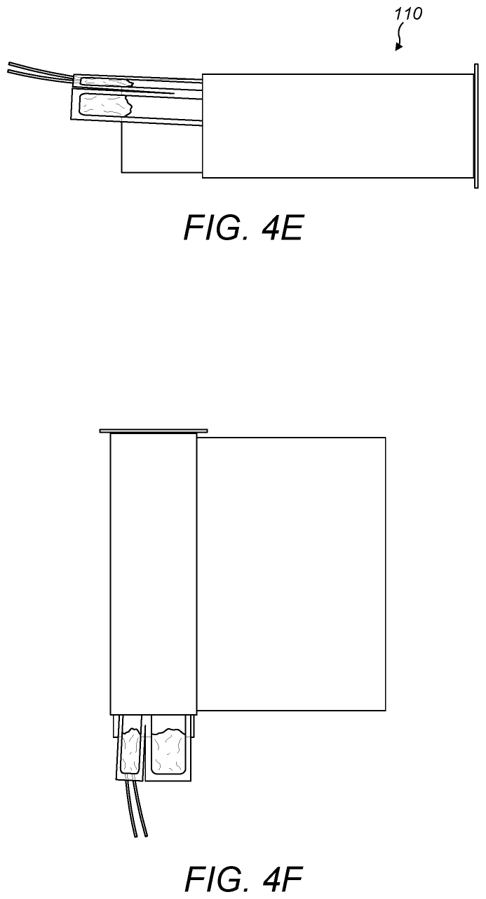

FIG. 4 illustrates a method of attaching the thin film heater 100 to a heating chamber 60 using a second flexible film 50. Firstly, if used, the release layer 31 is removed to expose the heating element 20 supported on the silicone adhesive side of the polyimide backing film 30. The second flexible film 50 is positioned so as to enclose the heating area 22 of the heating element between the backing film 30 and the second film 50, whilst leaving the heater legs 23 exposed for connection to a power source. In this example, the second flexible film 50 is a heat shrink material which allows for the thin film heater 100 to be tightly and securely attached to the outer surface of the tubular heating chamber 60. In particular the heat shrink film 50 comprises heat shrink tape which preferentially shrinks in one direction, such as heat shrink polyimide tape (for example 208x manufactured by Dunstone). By wrapping a layer of preferential heat shrink tape around the thin film heater 100 to secure it to the heating chamber with the direction of the preferential heat shrink aligned with the wrapping direction, upon heating, the heat shrink layer contracts to hold the thin film heater tightly against the heater chamber 60.

In the example of FIG. 4, the heat shrink film 50 is positioned over the heating area 22 of the heating element 20 on the surface of the thin film heater 100. The heat shrink 50 extends beyond the area of the flexible electrically insulating backing film 30 in a direction 51 corresponding to the direction in which the heater assembly 100 is wrapped around the heater cup 60 (and also the preferential shrink direction of the heat shrink film 50). In particular, the heat shrink film 50 extends beyond the backing film 30 and supported heater element 20 in a direction 51 approximately perpendicular to the direction in which the heating element contact legs 23 extend from the heating area 22. This corresponds to the wrapping direction 51 such that, when wrapped around the heating chamber 60, the heating area is aligned appropriately to extend around the circumference of the heating chamber, while the extending portion of the heat shrink film 50 wraps a second time around the circumference of the chamber 60 to cover the heating area 22.

The heat shrink film 50 preferably extends sufficiently in a direction 51 perpendicular to the heater contact legs in the wrapping direction, such that the wrapping portion may extend around the circumference of the heating chamber when the thin film heater 100 is wrapped around the heating chamber 60. The adhesive on the polyimide backing film 30 can affect the contraction of the heat shrink film under heating in areas in which the heat shrink film is in contact with the adhesive and therefore a sufficient extending region 51 which is free of the adhesive layer should be provided which can wrap around the heating chamber to ensure that the thin film 100 is securely and tightly attached to the heating chamber after heat shrinking.

The heat shrink film 50 also preferably extends upwardly (in a direction corresponding to the elongate axis of the heater chamber 60) beyond the heating element 20 in a direction 52, opposite to the direction of extension of the heater contact legs. By measuring this distance in direction 52 in which the heat shrink film extends above the heating area 22, the heating area 22 may be aligned at the correct height along the length of the heating chamber 60 as required. In particular, by ensuring the length by which the heat shrink extends in direction 52 is correct, and aligning this top edge of the upwardly extending portion of the heat shrink to the top edge 62 of the heating chamber, the heating area 22 can be reliably positioned at the correct point along the length of the heating chamber 60 during assembly of the heater 110.

As shown in FIG. 4B, a temperature sensor, referred as an example hereafter as thermistor 61 may be introduced between the polyimide backing film 30 and the heat shrink layer 50. The thermistor 61 is preferably attached adjacent to the heater track 21 on the silicone adhesive layer of the backing film 30. The heater track 21 may be etched in a pattern such that the path followed by the heater track leaves a region of the heater area 22v vacant such that the thermistor 61 may be applied in this area closely neighbouring the heater element 20. In this exemplary method, the heat shrink film 50 may be positioned so as to leave a free edge region 32 of the backing film 30 adjacent to the heating area 20. This free region 32 of the backing film may be on the side of the heater area 20 opposite to the extended wrapping portion 51 of the heat shrink material 50. This adhesive edge portion 32 may then be folded over to secure the heat shrink layer 50 and the enclosed thermistor 61 to the backing film 30.

The preliminary attachment of the thin film heater assembly 100 to the outer surface of the heater chamber 60 may be achieved in a number of different ways. In the method illustrated in FIG. 4, pieces of adhesive tape 55 are attached to each side of the thin film heater assembly 100 (at each far edge of the heat shrink 50 in the wrapping direction). Then, as shown in FIG. 4D, the thin film heater assembly 100 is attached to the heating chamber 60 with a piece of sticky tape 55a adjacent to thermistor 61, with the electrically insulating backing film 30 in contact with the outer surface of the heating chamber 60 and the heat shrink film 50 facing outwards. The heating area 20 is positioned by aligning the top side of the extending alignment portion 52 of the electrically insulating film with a top edge of the heating chamber 60. The thermistor 61, held between the heat shrink 60 and backing film 30, may be aligned so that it is positioned within a recess provided on the outer surface of the heating chamber 60. Elongate recesses may be provided around the circumference of the heating chamber 60 which protrude into the inner volume to enhance the heat transfer to a consumable during use in a device. By providing a thermistor 61 such that it lies within such a recess, a more accurate reading of the internal temperature of the heating chamber is obtained.

The thin film heater assembly 100 is then wrapped around the circumference of the heating chamber 60 so that the heating area 20 lies around the complete circumference of the heating chamber 60. The extending portion 51 of the heat shrink film 50 wraps around the heating chamber 60 so as to cover the heating element 20 with an additional layer on its outer surface. The extending wrapping portion 51 of the heat shrink material 50 is then attached using the corresponding attached portion of sticky tape 55b. The wrapped heater assembly 110 shown in FIG. 4E is then heated to heat shrink the thin film heater to the outer surface of the heating chamber 60. Finally, an electrically insulating thin film 56, such as polyimide film, may be applied with the around the outer surface of the heater assembly 110 to form one or several additional electrically insulating layers. The film may comprise an internal layer of adhesive (e.g. Si adhesive) to hold the wrapped film in place.

The method of FIG. 4 therefore provides a particularly efficient method in which the heat shrink film provides a number of functions, namely to seal the heating element against the backing film 30, to provide alignment features to allow alignment of the heating element 20 relative to the heating chamber 60 and to provide the means of attaching the heater assembly 100 to the heating chamber 60. In other example the heat shrink 50 may be attached in other ways. For example the heating element 20 may first be sealed by a second electrically insulating film to form a sealed dielectric envelope containing the heating element 20. This assembly may then be attached with the heat shrink by wrapping the heat shrink over the thin film heater assembly to at least particularly overlap with it and attach it to the chamber 60. In this case, since th heating element 20 is already sealed between two electrically insulating films, the heat shrink need not cover the heating area 22, as shown in FIG. 4. For example an edge of the heat shrink 50 film may be attached to an edge of the sealed thin film heater and then used to wrap it to the heater chamber 60. The heat shrink 50 may be wrapped in the form of a spiral; multiple pieces of heat shrink may be used, for example to secure just the edges of the thin film heater against the heating chamber 60; or it may be a heat shrink tube which is sleeved over the heating chamber 60 and thin film heater before heat shrinking.

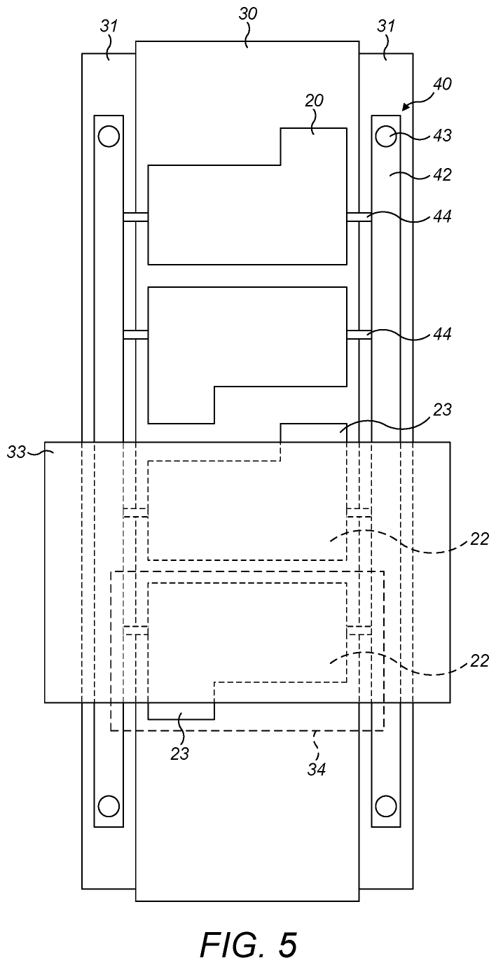

FIG. 5 illustrates an alternative method of assembling a thin film heater 100 using an array 40 of connected heating elements, as shown in FIG. 2B. The method of FIG. 5 utilises a heating element array 40 etched from a single metal sheet, as described above, to simplify the manufacturing process and increase the number of thin film heaters which may be produced in a given amount of time. The array 40 comprises a plurality of connected heating elements 20 suspended within a supporting frame 40 comprising elongate struts 42. The array 40 is placed onto a single common strip of polyimide/SI backing film 30 of sufficient length to support a row of multiple heating elements. Similarly, other electrically insulating materials such as fluoropolymer films of PEEK may be used. A vacuum bed may be used to precisely hold the polyimide tape 30 with the silicone adhesive side facing upwards. The array 40 of etched metal heating elements 20 may then be placed onto the silicone adhesive surface of the backing film 30. The holes 43 in the metal support struts 42 may be used to assist in precisely aligning the array of heater elements 20 onto the backing film 30.

Next, strips 31 of peelable release material (for example polyester) are applied along each side edge of the backing film strip 30. These pealable release strips may be peeled away when the thin film heater is assembled to reveal the adhesive layer of the polyimide/silicone tape and therefore replace the pieces of adhesive tape 55 of the method of FIG. 4. The strips 31 of peelable release material may be aligned with the support struts 42 of the metal frame to help with alignment. For example they may have corresponding holes to those in the support struts 42 which can be aligned with the use of pins provided on an alignment fixture, such as the vacuum bed.

Next, a second layer 33 of polyimide/SI film may be applied to be top surface of the assembly to seal the heating area of one or more heating elements between the two layers of polyimide tape. Preferably, as shown in FIG. 5 a second strip 33 of polyimide/Si tape is applied to cover the heating areas of two heating elements, leaving the contact legs 23 exposed on the top surface of the first piece 30 of backing film. The two pieces 30, 33 of polyimide/SI film may then be vacuum pressed to seal the heating areas 22 of the neighbouring heating elements 20 between the two pieces 30, 33 of electrically insulating film. The supporting struts 42 are then removed from the heating elements 20 (the supporting frame 40 can be removed prior to or after sealing the heating elements 20) by breaking the breakable portions 44 which connect the heating elements 20 to the support struts 42. Finally, the individual sealed heaters are die cut as shown by dashed line 34 to release the individual sealed heating elements 20. In this way, each individual sealed heating element comprises two pieces of release tape 31a, 31b which can be removed from the edges of the backing film to expose the adhesive surface of the polyimide/SI film 33 to allow attachment to the heating chamber 60. Therefore, this method does not require additional pieces of adhesive tape 55 to be attached to the backing film 30 in order to initially attach the heating element assembly 100 to the heating chamber 60.

The sealed individual heating element also has the contact legs 23 exposed for ease of connection to the power unit and PCB. Once the individual sealed heating elements have been released they can be attached to the heating chamber using strips of heat shrink film 50. This method therefore differs from that of FIG. 4 in that the heating elements 20 are sealed in envelopes of polyimide backing film on both sides, whereas the assembly of FIG. 4 only has a single layer of polyimide/SI film on which the heating element is attached before application of the heat shrink film. In the case of the method of FIG. 5 therefore, the heat shrink film does not need to seal the thin film heater but is just used for attachment purposes so the heat shrink can be applied in any manner to secure the thin film heater to the heating chamber 60. The method of FIG. 5 is achievable since the method according to the present invention, involving etching of the metal sheet independently of the backing film, allows for more complex and larger scale structures to be etched such that arrays of heating elements 40 as shown in FIG. 5 can be utilised.

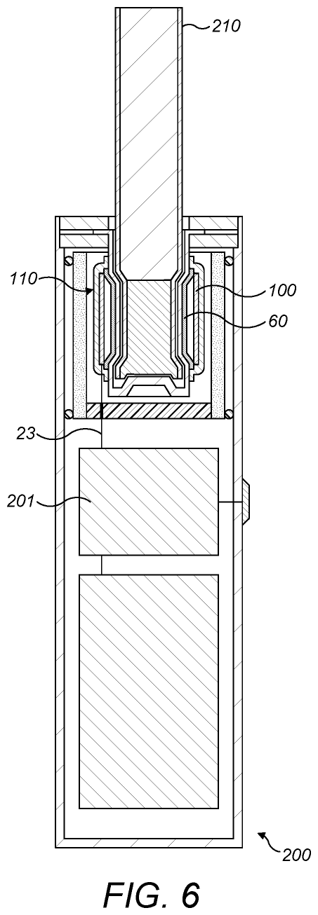

A heater assembly 110 comprising a thin film heater 100 manufactured by the method of the present invention wrapped around the outer surface of heating chamber 60 can be used in a number of different applications. FIG. 6 shows the application of a thin film heater 100, assembled according to the method of the present invention, applied in a heat not burn aerosol generating device 200. Such a device 200 controllably heats an aerosol generating consumable 210 in a heating chamber 60 in order to generate a vapour for inhalation without burning the material of the consumable. FIG. 6 illustrates a consumable 210 received in the heating chamber 60 of the device 200. The heater assembly 110 of the device 200 comprises a substantially cylindrical heat conducting chamber 60 with a thin film heater 100 according to the present invention wrapped around the outer surface.

Since the thin film heater 100 according to the present invention uses a reduced thickness of material the transfer of heat to the heating chamber is much more efficient than with known devices. In particular, since independently etching the heating element 20 allows for greater selection in terms of the thickness and materials of the backing film 30, backing films 30 with reduced thermal mass may be used to enhance heat transfer to the consumable 210 within the heating chamber 60, thereby improving the performance of the device. Furthermore, since the method of the present invention uses etching from both sides of the metal heating sheet the heating element may be manufactured to a much higher precision in which the width and thickness of the heating tracks 21 are uniform across the heating area 22 of the heating element 20. This results in more uniform heating of the heating chamber resulting in the entirety of the intended volume of the consumable 210 being heated more precisely to the required temperature to produce vapour. Furthermore, since the method allows for more design freedom in the specific shape of the heating element 20, a heating element 20 with extended contact legs 23 can be produced. In this way, as illustrated in FIG. 6, the contact legs 23 can extend directly to the PCB 201 where they can be connected. This reduces the number of manufacturing steps and the number of components required since additional cables which need to be soldered between the contact legs 23 and the PCB 201 are no longer required. This makes the device more fault resistance and more robust. A thin film heater manufactured according to the method of the present invention therefore imparts a number of improvements in performance when implemented in a device, such as an aerosol generating device.

1. A method of fabricating a thin film heater comprising:
etching a metal sheet from two opposing sides to provide a planar heating element; and
attaching the planar heating element to a flexible electrically insulating backing film.

2. The method of claim 1, wherein the etching step comprises photoetching the metal sheet.

3. The method of claim 1, wherein the planar heating element is attached to a surface of the flexible electrically insulating backing film using an adhesive.

4. The method of claim 1, wherein the etching step comprises etching the metal sheet to provide two or more connected heating elements.

5. The method of claim 1, wherein the etching step comprises etching the metal sheet to provide two or more connected heating elements supported within a support frame.

6. The method of claim 4, further comprising:
detaching each of the two or more connected heating elements and attaching each of the two or more connected heating elements to a corresponding piece of the flexible electrically insulating backing film.

7. The method of claim 4,
wherein the attaching step includes attaching the two or more connected heating elements to a common flexible electrically insulating backing film; and
further comprising cutting the common flexible electrically insulating backing film between the two or more heating elements to provide multiple assemblies comprising a single heater element attached to a flexible backing film.

8. The method of claim 1, wherein the etching step comprises etching the metal sheet to form a-the planar heating element comprising:
a heater track which follows a circuitous path covering a heating area within a plane of the planar heating element; and
two extended contact legs for connection to a power source.

9. The method of claim 8, wherein a length of the two extended contact legs is substantially equal to or greater than dimensions of the heating area.

10. The method of claim 8, further comprising:
attaching a second flexible film layer so as to enclose the heater track between the flexible electrically insulating backing film and the second flexible film layer.

11. The method of claim 10, wherein the second flexible film layer comprises a heat shrink material.

12. The method of claim 1, wherein the flexible electrically insulating backing film comprises polyimide.

13. The method of claim 1, wherein the flexible electrically insulating backing film comprises PTFE.

14. The method of claim 1, wherein the flexible electrically insulating backing film has a thickness of less than 50 μm.

15. A thin film heater fabricated by the method of claim 1.
